(19) United States
(12) Patent Application Publication
(10) Pub. No.: US 2026/0254022 A1
(43) Pub. Date: Aug. 27, 2026

(54) BATTERY PACK

(71) Applicant: ideaForge Technology Limited, Mumbai (IN)

(72) Inventors: Vikhyath Babu VAGOLU, Mumbai (IN); Sunil GHORUDE, Mumbai (IN); Vijaya Kumar VADDEPALLY, Mumbai (IN); Santosh MORE, Mumbai (IN); Rahul SINGH, Mumbai (IN); Ankit MEHTA, Mumbai (IN)

(21) Appl. No.: 19/468,167

(22) Filed: Feb. 3, 2026

(30) Foreign Application Priority Data
Feb. 3, 2025 (IN) 202521008853

(51) Int. Cl. H01M 50/24; H01M 10/613; H01M 10/615; H01M 10/625; H01M 10/635; H01M 10/6551; H01M 10/6563; H01M 10/6571; H01M 50/213; H01M 50/227; H01M 50/249; H01M 50/291; H01M 50/507; H01M 50/583

(52) U.S. Cl. CPC H01M 50/24; H01M 10/613; H01M 10/615; H01M 10/625; H01M 10/635; H01M 10/6551; H01M 10/6563; H01M 10/6571; H01M 50/213; H01M 50/227; H01M 50/249; H01M 50/291; H01M 50/507; H01M 50/583; H01M 2220/20

(57) ABSTRACT

A battery pack comprises a plurality of battery cells, and at least one cell retention structures arranged in engagement with the battery cells. The cell retention structures includes a fire-retardant foam and is arranged adjacent to electrical interconnection components of the battery cells including a plurality of busbars connecting terminals affixed at upper and lower sides of the battery pack. During an abnormal thermal event affecting one of the battery cells, the cell retention structures resist failure of at least one associated electrical interconnection component, thereby preventing propagation of the thermal event to the adjacent battery cells. Each busbar includes at least one controlled failure region configured such that, when current through the corresponding busbar exceeds a predefined threshold, the controlled failure region fails and interrupts current flow and, electrically isolate the affected battery cell.

### CROSS REFERENCE TO RELATED APPLICATIONS

This application claims the benefit of Indian Patent Application No. IN 202521008853, filed Feb. 3, 2025, the content of which is hereby incorporated by reference in its entirety.

### TECHNICAL FIELD

The present disclosure relates to the technical field of battery packs. In particular, the present disclosure pertains to a lightweight battery pack with features that enhance fire safety, prevent thermal runaway, and efficiently manages heat, without compromising energy density.

### BACKGROUND

Background description includes information that may be useful in understanding the present invention. It is not an admission that any of the information provided herein is prior art or relevant to the presently claimed invention, or that any publication specifically or implicitly referenced is prior art.

Multi-cell battery packs, particularly in unmanned aerial vehicles (UAVs), besides the challenge of minimizing their weight, face significant challenges in safety and thermal management. A major concern is a thermal runaway, where overheating in one battery cell can trigger a chain reaction, causing adjacent battery cells to fail as well. This cascading failure can lead to catastrophic consequences, making it crucial to prevent the thermal runaway and control its spread.

Besides safety, efficient thermal management is also essential to maintain optimal battery performance, especially under varying temperature conditions. Existing solutions, such as fire-retardant or phase-change materials (such as wax) and liquid cooling systems, are effective in electric vehicles but add excessive weight. In UAV applications, where minimizing weight is critical, these solutions are impractical, as they reduce energy density and the cell-to-pack weight ratio.

There is, therefore, a need to overcome the above-mentioned drawbacks, shortcomings, and limitations associated with the existing battery packs, and provide a lightweight battery pack that enhances fire safety, prevents thermal runaway, and efficiently manages heat, without compromising energy density.

### OBJECTIVES OF THE INVENTION

An object of the present disclosure is to provide a battery pack that overcomes above-mentioned limitations of the existing battery packs for unmanned aerial vehicles.

An object of the present disclosure is to provide a battery pack that prevents propagation of thermal runaway between battery cells, thereby ensuring safety and minimizing the risk of cascading failures.

An object of the present disclosure is to provide a battery pack that reduces likelihood of fire hazards without adding significant weight.

Another object of the present disclosure is to develop a lightweight and compact battery pack design by minimizing incorporation of bulky fire-safety and cooling components, maintaining high energy density and an optimal cell-to-pack weight ratio, particularly for UAV applications.

Yet another object of the present disclosure is to provide a scalable, simple and cost-effective battery pack that can be implemented in a wide range of applications, especially in UAVs, where weight, safety, and performance are critical factors.

### SUMMARY

Aspects of the present disclosure relate generally to the technical field of thermal management systems for battery packs. In particular, the present disclosure pertains to a lightweight battery pack that enhances fire safety, prevents thermal runaway, and efficiently manages heat, without compromising energy density. According to an aspect, the disclosed battery pack includes a plurality of battery cells and at least one cell retention structure arranged in engagement with the battery cells. The cell retention structure comprises a fire-retardant foam and is positioned adjacent to electrical interconnection components of the battery cells, including busbars connecting battery cell terminals.

The cell retention structure is configured to provide mechanical retention and protection to the electrical interconnection components. During an abnormal thermal event affecting a battery cell, the fire-retardant foam resists failure of at least one associated electrical interconnection component, thereby preventing propagation of the abnormal thermal event to adjacent battery cells.

In another aspect, each busbar includes at least one controlled failure region configured to fail or interrupt electrical continuity when current through the busbar exceeds a predefined threshold, thereby electrically isolating an affected battery cell. In certain embodiments, the battery pack may further include spacers, predefined gaps for convective cooling, heating elements for cold-weather operation, temperature sensors with a controller, and a battery enclosure configured with airflow features to facilitate thermal regulation.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary isometric view of a proposed battery pack configured with a plurality of busbars connecting terminals affixed at upper and lower sides of the battery pack, in accordance with one or more embodiments of the present disclosure.

FIG. 2 illustrates another exemplary isometric view of the proposed battery pack configured with a heating element disposed on at least one of the upper side and lower side of the battery pack adjacent the corresponding busbars to facilitate heating of the battery pack during cold operating conditions, in accordance with one or more embodiments of the present disclosure.

FIG. 3A illustrates an exemplary view of a battery enclosure of the battery pack, in accordance with one or more embodiments of the present disclosure.

FIG. 3B illustrates an exemplary cross-sectional side view for cutting plane line X-X of the battery enclosure of FIG. 3A, in accordance with one or more embodiments of the present disclosure.

FIG. 3C illustrates an exemplary side view of the battery enclosure of FIG. 3A, in accordance with one or more embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate to the technical field of thermal management systems for battery packs. In particular, the present disclosure pertains to a lightweight battery pack that enhances fire safety, prevents thermal runaway, and efficiently manages heat, without compromising energy density.

Existing battery packs, especially those used in Unmanned Aerial Vehicles (UAVs), suffer from several key limitations. Existing designs of the battery packs rely on heavy fire-safety and thermal management solutions, such as fire-retardant materials, phase-change materials such as wax, and liquid cooling systems. While these solutions are effective at preventing fires and managing temperature, they significantly increase the weight and complexity of the battery pack. This excess weight reduces energy density and overall efficiency of the battery pack, which is a critical limitation in UAV applications where minimizing weight is essential for optimal performance. Moreover, these battery packs often fail to adequately prevent the spread of thermal runaway between battery cells, posing serious safety risks in multi-cell battery packs. As a result, existing battery packs are not ideal for applications that require a lightweight structure, high energy density, and effective thermal management.

In an embodiment, the disclosed battery pack may include a plurality of battery cells arranged in a predetermined configuration and at least one structural cell retention structure arranged in contact with and adjacent to the plurality of battery cells. The at least one cell retention structure may be configured to mechanically retain the battery cells and to interface with an at least one electrical interconnection components of the battery cells, including terminals and current-carrying interconnection elements such as busbars. In one embodiment, the battery pack includes a pair of cell retention structures, that may further include an upper cell retention structure and a lower cell retention structure disposed on corresponding sides of the plurality of battery cells, while in other embodiments, the battery pack may include a single cell retention structure disposed on one side of the plurality of battery cells. Each cell retention structure comprises at least a fire-retardant material and is positioned relative to the plurality of battery cells such that the structure performs both a mechanical retention function and a protective function with respect to electrical interconnection components during operation of the battery pack.

In one embodiment, the cell retention structure may include a fire-retardant material deposited on both an upper side and a lower side of the plurality of battery cells such that electrical interconnection components of the battery cells, including terminals and current-carrying interconnection elements, are at least partially enclosed or protected. In said embodiment, the fire-retardant material may be positioned adjacent to the electrical interconnection components to limit propagation of heat, flame, or mechanical failure from one battery cell to adjacent battery cells during operation or abnormal thermal events.

In another embodiment, the cell retention structure may include a fire-retardant material disposed on only one side of the plurality of battery cells, while an opposing side of the plurality of battery cells may remain free of the fire-retardant material. Such selective or partial deposition of the fire-retardant material reduces overall battery pack weight while maintaining protective functionality for electrical interconnection components located on the side provided with the fire-retardant material.

In an embodiment, the fire-retardant material forming at least a portion of the cell retention structure is configured to resist propagation of thermal, mechanical, or electrical failure originating from a battery cell or an associated electrical interconnection component. During an abnormal thermal event affecting a battery cell, the fire-retardant material cooperates with the cell retention structure to limit transfer of heat, flame, molten material, or mechanical energy to adjacent battery cells and associated electrical interconnection components, thereby reducing the likelihood of cascading failure within the battery pack.

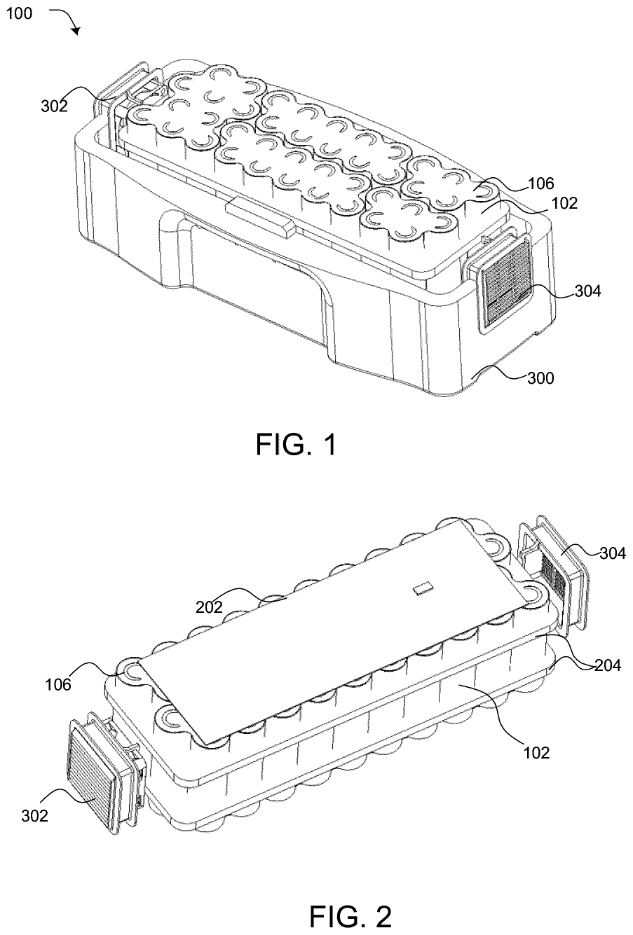

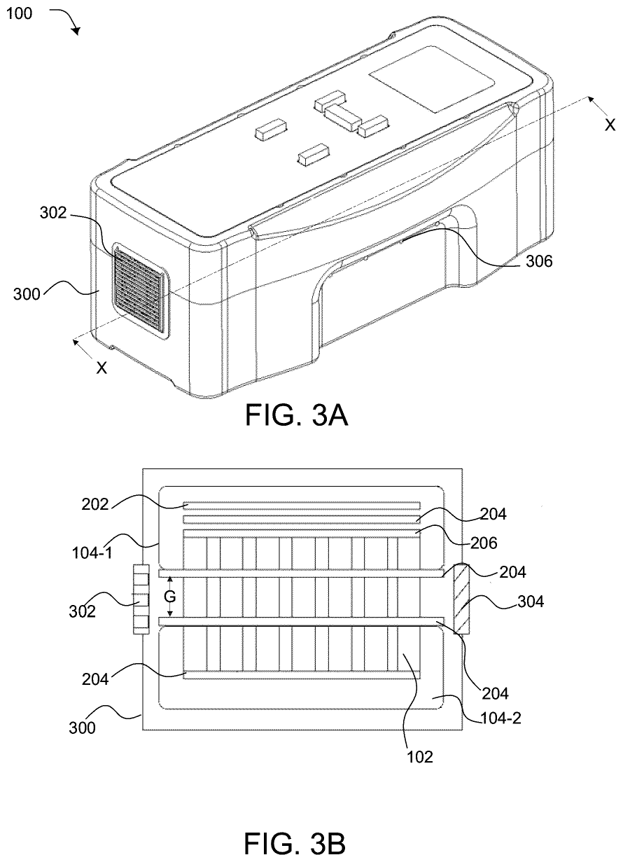

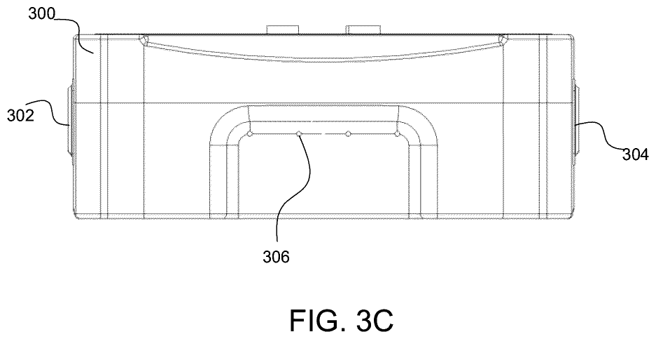

Referring to FIG. 1, the disclosed battery pack 100 includes a plurality of battery cells 102 (collectively referred as “battery cells 102” hereinafter), and a pair of cell retention structures 104 (collectively referred as “cell retention structures 104” or at least one cell retention structures 104 hereinafter) including an upper cell retention structure 104-1 and a lower cell retention structure 104-2 in engagement with respective sides of the battery cells 102. Each of the cell retention structures 104 (shown in FIG. 3B) includes at least a fire-retardant foam (collectively referred as “fire-retardant foam” or “fire-retardant material” hereinafter) and is configured to cover a plurality of busbars 106 (collectively or individually referred as “busbars 106” or “busbar 106” hereinafter) connecting terminals affixed at the upper and lower sides of the battery pack 100. The fire-retardant foams can be low density foams selected from a group consisting of but not limited to: Polyurethane (PU) foams, Expanded Polystyrene (EPS) Foams, Polyethylene (PE) Foams, phenolic foams, melamine foams, intumescent foams, and silicone foams. The configuration of components referred as 300, 302, and 304 in FIGS. 1 and 2 are clearly visible in FIG. 3A, and elaborately described in the description below.

In an implementation, during an abnormal thermal event in one of the plurality of battery cells 102, the cell retention structures 104 may include the fire-retardant material which resists degradation or failure of electrical interconnection components associated with the affected battery cell 102. As used herein, failure of the electrical interconnection component includes, without limitation, rupture, fracture, cracking, bending, loosening, detachment, melting, or partial or complete loss of electrical or mechanical integrity. By resisting such failure, the cell retention structure 104 reduces propagation of the abnormal thermal event to adjacent battery cells 102. In another embodiment, the fire-retardant material forming the cell retention structure 104 may be used in combination with one or more mechanically resilient materials to provide higher resistance to mechanical deformation or impact during abnormal events. Such mechanically resilient materials may include, without limitation, elastomeric foams, elastomeric pads, intumescent materials, fiber-reinforced composite mats, ceramic-fiber based resilient layers, multilayer composite structures, viscoelastic elastic damping materials, or combination thereof. The selection and arrangement of such materials may vary depending on the desired balance between mechanical resilience, fire resistance, and overall battery pack weight. In another embodiment, the cell retention structure 104 is made of hybrid layers of different fire-retardant foam and mechanically resilient materials.

In an embodiment, the cell retention structure 104 may be positioned relative to the plurality of battery cells 102 such that a pre-defined gap is formed adjacent to the plurality of battery cells 102. The pre-defined gap defines a thermal flow passage configured to permit circulation of a cooling medium adjacent to at least a portion of the battery cells 102 during operation of the battery pack 100. The presence of the pre-defined gap facilitates removal of heat generated by the battery cells 102 and contributes to maintaining the battery cells 102 within a desired operating temperature range.

As used herein, the term “busbar” refers to an electrically conductive bar, plate, strip, or laminated conductor configured to distribute electrical current between multiple battery cells or electrical nodes within a battery pack. The term “electrical interconnection component” refers to any electrically conductive structure configured to provide electrical continuity between battery cells or cell terminals, including busbars, electrode tabs, welded or bonded joints, flexible or rigid conductive straps, laminated conductors, stamped interconnection members, and functionally equivalent current-carrying structures.

In an embodiment, each of the busbars 106 may include at least one controlled failure region configured to fail or interrupt electrical continuity when electrical, thermal, or mechanical conditions associated with current through the busbars 106 exceed a predefined threshold. The at least one controlled failure region can fail because of one or more factors including, but not limited to, increase in temperature, thermal expansion, mechanical stress, notches, perforations, thinning, etc. associated with the increase of the current beyond a threshold. The at least one controlled failure region can be formed by at least one of a localized reduction in structural capacity like a cross-sectional area, a region of reduced material strength, a region of material discontinuity like a joint, interface, crack, notch (in FIG. 1, the busbar 106 shows the moon like notches that act as the failure points), groove, perforations etc. or material weakening such that, when current through the corresponding busbar 106 exceeds a predefined current value, the portion with the at least one controlled failure region fails and interrupts flow of current there through, thereby isolating the corresponding battery cell among the plurality of battery cells 102. The at least one controlled failure region can fail as being melting of the region, vaporizing of the region, breaking of the region, thinning of the region, composition changing of the region etc. A person skilled in the art would appreciate the busbar 106 with the portion of the at least one controlled failure region as a critical design feature for safety and reliability of the battery pack 100. This design allows the portion with at least one controlled failure region to fail or break when the current exceeds a predetermined threshold during an overcurrent or short circuit event, preventing further damage to the rest of the battery pack 100 and minimizing the risk of thermal runaway.

In one embodiment, the at least one controlled failure region may be implemented as a fusible portion of the busbar 106 having a reduced cross-section relative to adjacent portions of the busbar 106. In such an embodiment, the reduced cross-section may be configured to thermally degrade or melt when current through the busbar exceeds the predefined threshold, thereby interrupting electrical continuity and electrically isolating the corresponding battery cell from the plurality of battery cells 102. Such controlled isolation limits propagation of abnormal electrical or thermal conditions within the battery pack 100. This fusible reduced cross-section embodiment provides a predictable and thermally driven failure mode for cell isolation.

The battery cells 102 can be connected through the busbars 106 in a configuration selected from any one of but not limited to: a series configuration, a parallel configuration, or combination thereof. For example, in the series configuration, the battery cells 102 can be connected end-to-end. i.e. a positive terminal of one battery cell is connected to a negative terminal of the adjacent battery cell. In parallel configuration, the positive terminals of the battery cells 102 are connected together, and the negative terminals are connected together. The parallel configuration can be used to increase the capacity of the battery pack 100 for longer runtime or higher power output, while maintaining same voltage.

The busbars 106 can be selected from but not limited to flat busbars, round busbars, flexible busbars, insulated busbars, and the like. The busbars can be made of material having good electrical conductivity, such as copper, aluminium, copper-alloys such as bronze, tin, and the like, stainless steel, tungsten, carbon-based materials, and the like, without any limitations whatsoever.

In an embodiment, each of the cell retention structures 104 can include aspacer 204 (collectively may also be referred to as “one or more spacer 204” hereinafter) located on an inner side of the corresponding cell retention structure 104. The spacer 204 can be made of a hard foam with a plurality of apertures for interference fit of the battery cells 102 there through. The selection of the hard foam to be used for making the spacer 204 can depend on various factors such as but not limited to thermal insulation, fire resistance, mechanical strength, weight, and cost. The hard foam can be selected from but not limited to Polyurethane (PU) Foam, Polyethylene (PE) Foam, Expanded Polystyrene (EPS) Foam, Phenolic Foam, Melamine Foam, Polyimide Foam, Epoxy Resin Foam, and the like.

As can be appreciated the inclusion of the apertures in the spacer 204 allows for the snug interference fit with the battery cells 102, providing mechanical support while minimizing movement of the battery cells 102 within the battery pack 100. In addition, the spacer 204 as made of the hard foam can also absorb vibrations created due to mechanical shocks or impacts during handling, transportation, or accidental collision of the battery pack 100.

The one or more spacers 204 corresponding to the upper and lower cell retention structures 104 can be positioned at a distance from a corresponding end of the battery cells 102. The fire-retardant foam can be poured over the one or more spacers 204 to cover the busbars 106 and the terminals on the corresponding sides to create the corresponding cell retention structure 104.

Further, in one embodiment the one or more spacers 204 associated with the cell retention structure 104 are positioned at the distance from the corresponding end of the plurality of battery cells 102 such that a pre-defined air gap G is formed between opposing portions of the cell retention structure. During normal operation, the battery cells 102 generate heat. If the heat is not dissipated properly, it can cause thermal build-up, which can lead to damage of the battery pack 100, degradation of performance of the battery pack 100, or even thermal runaway in extreme cases. In one embodiment, the pre-defined gap G can allow convective heat transfer, which may occur through natural convection or forced convection, depending on operating conditions and configuration of the battery pack 100. The cooling medium may include, without limitation, air, conditioned air, inert gas, or a mixture of air and liquid droplets. While designing the pre-defined air gap G (also referred as “gap G” hereinafter), the individual should take into account factors such as size of the gap G, material selection, and airflow properties. The size of the gap G can be based on parameters such as but not limited to battery cell size and type, design of the battery pack 100, configuration of the battery pack 100, and ambient conditions.

For the purposes of providing a clearer representation of the busbars 106, the one or more spacers 204, and the battery cells 102, the cell retention structures 104 are omitted from FIGS. 1 and 2. It is understood that the omission of the cell retention structures 104 does not affect the scope or the functionality of the present disclosure, and their inclusion in the actual embodiment of the present disclosure is contemplated. The cell retention structures 104 are designed to securely accommodate and support the battery cells 102 in their operative configuration, ensuring proper alignment and stability, but are not essential for understanding the inventive aspects as depicted in the present figure.

Referring to FIG. 2, the battery pack 100 includes a heating element 202 which may be disposed or positioned on an upper side, a lower side, or both sides of the battery pack 100, adjacent to the corresponding busbars 106, depending on the desired heating performance and battery pack 100 configuration. The heating element 202 may facilitate heating of the battery pack 100 during cold operating conditions. The heating element 202 can be in form of a heating coil film strip (simply referred as “strip” hereinafter) may include a flexible, thin substrate, embedded with a resistive heating coil or strip. The thin substrate can be made of materials such as polyester, polyimide, or the like, without any limitations. The coil can be made of material having high electrical resistance, such as but not limited to nichrome, copper, or carbon-based materials.

A skilled practitioner in the field would appreciate the selection of the heating element 202 in the form of the strip, as the strip can easily conform to curved or irregular surfaces, thereby making it best choice for applications where space is limited as in case of the battery pack. Moreover, the strip is much lighter in weight and more compact than traditional bulky heating elements, providing efficient heating without adding significant weight.

In an exemplary embodiment, the battery pack 100 is implemented for use in UAV applications. In UAV applications, the heating element 202 may be powered by an external power source or by the battery pack 100 itself. The heating element 202 may be activated prior to operation of the battery pack 100 to pre-heat the plurality of battery cells 102 to a desired temperature range, or may be selectively activated during operation based on detected temperature conditions. In another embodiment, the battery pack 100 can include one or more temperature sensors (not shown) (collectively referred as “temperature sensors” hereinafter) operatively coupled to a controller (not shown) of the battery pack 100. The temperature sensors may be located at one or more pre-defined positions within the battery pack 100 to sense temperature of the battery pack 100. The pre-defined positions can include but not limited to central location of the battery pack 100, near the battery cells 102, and near edges of the battery pack 100.

In an implementation, during cold weather conditions, when the sensed temperature of the battery pack 100 is detected to be below a threshold temperature value the controller (not shown) of the battery pack 100 can actuate the heating element 202 to initiate pre-heating of the battery pack 100 before initiating powering one or more units getting power from the battery pack 100.

The temperature sensors can be selected from but not limited to thermocouple-based temperature sensors, Resistor Temperature Detector (RTD) sensors, thermistor-based sensors, Infrared (IR) temperature sensors, semiconductor-based temperature sensors, and the like.

In an exemplary embodiment, the controller may be implemented using various hardware configurations or a combination of software and hardware features. For instance, the controller may incorporate microcontrollers, switches, relays, gates, and specialized hardware features like application-specific integrated circuits (ASICs), electrically erasable programmable read-only memories (EEPROMs), or field-programmable gate arrays (FPGAs). In some cases, memory components like non-volatile random access memory (RAM) or read-only memory (ROM) may also form part of the controller. In another embodiment, the controller may be entirely software-based, operating either as part of an operating system or as an application running on one. The controller may be connected to the heating element 202 or other components of the battery pack 100 either wirelessly or in a wired manner.

In an embodiment, the battery pack 100 can include a heat sink 206 (Refer to FIG. 3B) located between the heating element 202 and the corresponding busbars 106. The heat sink 206 can be in a form of a thin film made of a thermally conducting but electrically insulating material to facilitate even distribution of heat from the heating element 202 and electrically isolate the heating element 202 from the busbars 106. The heat sink 206 ensures that heat generated by the heating element 202 can spread evenly across the battery pack 100, preventing hot spots that could lead to thermal damage or battery cell degradation. Additionally, insulating property of the heat sink 206 can prevent any direct electrical contact between the heating element 202 and the busbars 106, thereby reducing the risk of short circuits and ensuring that the heating element 202 can operate safely.

The heat sink 206 can be made of material such as but not limited to ceramic materials like aluminium oxide, or boron nitride, thermally conductive materials like polymide, or polycarbonate, or composite materials like carbon-fiber-reinforced plastics or thermoplastic polymers. The heat sink 206 can be formed in different design such as but not limited to thin film heat sink, micro-channel heat sink, stacked heat sink layers, flexible heat sinks, and the like. In a preferred embodiment, the heat sink can be designed as the thin film heat sink, as these are extremely lightweight and can be used where space is limited. In one embodiment, at least one of the cell retention structures 104 includes the fire-retardant foam and is configured to cover the plurality of busbars 106 connecting terminals affixed at the upper or the lower sides of the battery pack 100 along with the heating element 202 and the heat sink 206.

Referring to FIGS. 3A-3C, in an embodiment, the disclosed battery pack 100 includes a battery enclosure 300 accommodating the plurality of battery cells 102 and one or more cell retention structures 104 depicted in FIG. 1. In alternate embodiment, the battery enclosure 300 can accommodate the battery cells 102, the cell retention structures 104, and the heating element 202 (Refer to FIG. 2) disposed on at least one of the upper side and lower side of the battery pack 100 to facilitate heating of the battery pack 100 during cold operating conditions.

The battery enclosure 300 can include a plurality of vents 302 (collectively referred as “vents 302” hereinafter), and an exhaust fan 304. The vents 302 can be configured at a front surface of the battery enclosure 300 for ingress of ambient air from surroundings. The exhaust fan 304 can be configured centrally at a rear surface, opposite to side configured with the vents 302, of the battery enclosure 300 to create forced convection based circulation of the ambient air within the battery pack 100 to cool down the battery cells 102, such that the ambient air is sucked in, circulated through the battery pack 100 and thereafter the hot air is pushed out of the battery pack 100 by the exhaust fan 304.

As can be appreciated the exhaust fan 304 can allow for better control over the airflow direction. The exhaust fan 304 can draw air from one side and expels it from another, which helps ensure that airflow goes exactly where needed, particularly when there are complex layouts or multiple components inside the battery pack 100 that require precise cooling.

In an embodiment, the battery enclosure 300 can include a plurality of bleed holes 306 (collectively referred as “bleed holes 306” hereinafter) configured at any side surface of the battery enclosure 300. The bleed holes 306 (Refer to FIG. 3C) in conjunction with the vents 302 can facilitate ingress of the ambient air to cool down the plurality of battery cells 102. The vents 302 and the bleed holes 306 in the battery enclosure 300 can be designed, based on the requirement of thermal management of the battery pack 100.

In an embodiment, the exhaust fan 304 can be connected to a separate circuit with the temperature sensors. The circuit can start the exhaust fan 304 at a higher threshold temperature and stop the exhaust fan 304 at a lower-threshold temperature. The exhaust fan 304 can be operatively connected the temperature sensors. When the temperature of the battery pack 100 exceeds the minimum threshold temperature, the controller of the battery pack 100 can send an actuation signal to the exhaust fan 304 to start cooling the battery pack 100. In case, when the sensed temperature by the temperature sensors is below the minimum threshold temperature, the controller can deactivate the exhaust fan 304.

In an embodiment, the battery enclosure 300 can be made of Expanded Polypropylene (EPP) foam. In alternate embodiment, the battery enclosure 300 can be made of materials such as but not limited to Expanded Polystyrene (EPS) foam, Polyethylene (PE) foam, or other lightweight, durable, and insulating materials.

In hot weather conditions, to provide cooling of the battery pack 100, the pre-defined gap G present in between the upper and lower cell retention structures 104 play an important role. This pre-defined gap G which is a minimum air gap along with the presence of the vents 302 and/or the bleed holes 306 present in the EPP foam enclosure 300 and the exhaust fan 304 helps in cooling down the entire battery pack 100.

In an embodiment, the battery pack 100 can include a display unit (not shown) configured at a top or side surface of the battery pack 100. The display unit can be configured to display one or more information pertains to the battery pack 100, where the one or more information is at least one of but not limited to: state of charge, health, temperature, voltage, cycle count, and error alerts of the battery pack 100. The display unit can include but not limited to Liquid Crystal Display (LED) panels, Organic Light Emitting Diode (OLED) displays, touchscreen display, and the like.

An individual with expertise in the field would appreciate the ability to combine both heating and cooling mechanisms in the one battery pack 100 is a technical advancement, as it allows the battery pack 100 to perform optimally in a wide range of environmental conditions, from cold weather conditions to extreme hot conditions. Further, the selective deposition of at least a fire-retardant foams around components such as battery terminals and busbars 106 significantly enhances fire safety. By enclosing the battery terminals and connections with the fire-retardant foam, the battery pack 100 offers enhanced protection against short circuits or thermal runaway, which are key causes of fires in the battery pack 100. Additionally, the low-density fire-retardant foams and lightweight design offer a significant weight reduction, which is a crucial feature in applications such as in UAV applications, where every gram counts toward efficiency and performance. These advancements ensure the battery pack 100 offers not only improved thermal control but also enhanced safety, making it a reliable and high-performance choice for various demanding applications.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### ADVANTAGES OF THE INVENTION

The present invention provides a battery pack designed to overcome above-mentioned limitations of the existing battery packs.

The present invention provides a battery pack that prevents the propagation of thermal runaway between battery cells, thereby ensuring safety and minimizing the risk of cascading failures.

The present invention provides a battery pack that reduces the likelihood of fire hazards without adding significant weight.

The present invention provides a lightweight and compact battery pack design by minimizing incorporation of bulky fire-safety and cooling components, maintaining high energy density and an optimal cell-to-pack weight ratio, particularly for UAV applications.

The present invention provides a scalable, simple and cost-effective battery pack that can be implemented in a wide range of applications, especially in UAVs, where weight, safety, and performance are critical factors.

We claim:

1. A battery pack comprising:
a plurality of battery cells,
at least one cell retention structure arranged in contact with the plurality of battery cells; wherein the at least one cell retention structure comprises at least a fire-retardant foam and is arranged adjacent to at least one electrical interconnection components of the plurality of battery cells including a plurality of busbars.

2. The battery pack as claimed in claim 1, wherein, during an abnormal thermal event affecting one of the plurality of battery cells, the at least one cell retention structure comprising the fire-retardant foam is configured to resist failure of the at least one electrical interconnection component associated with the affected battery cell, thereby reducing propagation of the abnormal thermal event to adjacent battery cells.

3. The battery pack as claimed in claim 1, wherein the at least one cell retention structure comprises one or more spacer located on inner side of the at least one cell retention structure.

4. The battery pack as claimed in claim 3, wherein the one or more spacer is made of a hard foam with a plurality of apertures for interference fit of the plurality of battery cells therethrough.

5. The battery pack as claimed in claim 3, wherein the one or more spacer corresponding to an upper cell retention structure and a lower cell retention structure are positioned at a distance from a corresponding end of the plurality of battery cells, and wherein the at least a fire-retardant foam is poured over the one or more spacer to cover the plurality of busbars and terminals on the corresponding sides to create the corresponding at least one cell retention structure.

6. The battery pack as claimed in claim 3, wherein the one or more spacer corresponding to the upper cell retention structure and the lower cell retention structure are positioned at the distance from the corresponding ends of the plurality of battery cells such that a pre-defined air gap (G) exists therebetween to allow circulation of a cooling medium for dissipating heat generated during operation of the battery pack.

7. The battery pack as claimed in claim 1, wherein the at least one cell retention structure comprises the fire-retardant foam and partially encapsulates at least a portion of the plurality of busbars and the at least one electrical interconnection component of the plurality of battery cells.

8. The battery pack as claimed in claim 1, wherein each of the plurality of busbars comprises at least one controlled failure region configured such that, when current through the corresponding busbar exceeds a predefined current value, the portion of the at least one controlled failure region fails and interrupts flow of current therethrough, thereby isolating the corresponding battery cell among the plurality of battery cells.

9. The battery pack as claimed in claim 1, comprising a heating element disposed on at least one of upper side and lower side of the battery pack adjacent the corresponding busbars, wherein the heating element causes heating of the battery pack during cold operating conditions.

10. The battery pack as claimed in claim 9, comprising a heat sink located between the heating element and the corresponding busbars, wherein the heat sink is in the form of a thin film made of a thermally conducting but electrically insulating material to facilitate even distribution of heat from the heating element and electrically isolate the heating element from the plurality of busbars.

11. The battery pack as claimed in claim 9, comprising one or more temperature sensors located at one or more pre-defined positions within the battery pack, the one or more temperature sensors are configured to sense temperature of the battery pack, and a controller operatively coupled to the one or more temperature sensors and the heating element,
wherein the controller is configured to actuate the heating element when the sensed temperature of the battery pack is below a threshold temperature value to initiate pre-heating of the battery pack.

12. The battery pack as claimed in claim 1, wherein the at least one cell retention structure is positioned relative to the plurality of battery cells such that the pre-defined gap (G) is formed adjacent to the plurality of battery cells, the pre-defined gap (G) defining a thermal flow passage configured to permit convective cooling using a cooling medium for dissipating heat generated during operation of the battery pack.

13. The battery pack as claimed in claim 12, wherein the convective cooling is a forced convective cooling, and wherein the cooling medium comprises air.

14. The battery pack as claimed in claim 12, comprising a battery enclosure accommodating the plurality of battery cells and the at least one cell retention structures, wherein the battery enclosure comprises a plurality of vents configured on a front surface of the battery enclosure for ingress of cooling medium from surroundings, and an exhaust fan configured centrally at a rear surface of the battery enclosure to draw the cooling medium through the battery enclosure for convective cooling of the plurality of battery cells.

15. The battery pack as claimed in claim 13, wherein the battery enclosure is made of Expanded Polypropylene (EPP) foam.

16. The battery pack as claimed in claim 1, wherein the fire-retardant foam is a low-density foam selected from any or in a combination of: Polyurethane (PU) foams, Expanded Polystyrene (EPS) Foams, Polyethylene (PE) Foams, phenolic foams, melamine foams, intumescent foams, and silicone foams.

17. The battery pack as claimed in claim 1, wherein the plurality of battery cells is connected through the plurality of busbars in a configuration selected from any one of: a series configuration, a parallel configuration, or any combination thereof.

18. A battery pack comprising:
a plurality of battery cells;
at least one cell retention structures comprising an upper cell retention structure and a lower cell retention structure respectively in engagement with upper and lower sides of the plurality of battery cells;
wherein each of the at least one cell retention structures covers a plurality of busbars connecting terminals affixed at upper and lower sides of the battery pack; and
wherein each of the plurality of busbars comprises at least one controlled failure region such that, when current through the corresponding busbar exceeds a predefined current value, a portion of the at least one controlled failure region fails and interrupts flow of current there through, thereby isolating the corresponding battery cell among the plurality of battery cells.

19. A battery pack comprising:
a plurality of battery cells;
at least one cell retention structures comprising an upper cell retention structure and a lower cell retention structure respectively in engagement with upper and lower sides of the plurality of battery cells;
wherein each of the at least one cell retention structures covers a plurality of busbars connecting terminals affixed at upper side and lower side of the battery pack; and
wherein the battery pack comprises a heating element disposed on at least one of the upper side and lower side of the battery pack adjacent the corresponding busbars to facilitate heating of the battery pack during cold operating conditions.

20. The battery pack as claimed in claim 18, comprising a heat sink located between the heating element and the corresponding busbars, wherein the heat sink is in a form of a thin film made of a thermally conducting but electrically insulating material to facilitate even distribution of heat from the heating element and to electrically isolate the heating element from the plurality of busbars.

21. The battery pack as claimed in claim 18, comprising one or more temperature sensors located at one or more pre-defined positions within the battery pack to sense temperature of the battery pack, wherein when the sensed temperature of the battery pack, and a controller operatively coupled to the one or more temperature sensors and the heating element, wherein the controller is configured to actuate the heating element when the sensed temperature of the battery pack is below a threshold temperature value to initiate pre-heating of the battery pack.
